(19) United States
(12) Patent Application Publication
(10) Pub. No.: US 2011/0087595 A1
(43) Pub. Date: Apr. 14, 2011

(54) METHOD AND SYSTEM FOR FACILITATING COMMERCIAL PURCHASES

(76) Inventor: Paul Sabella, Columbia, MD (US)

(21) Appl. No.: 12/901,085

(22) Filed: Oct. 8, 2010

Related U.S. Application Data
(60) Provisional application No. 61/272,593, filed on Oct. 9, 2009.

(51) Int. Cl. G06Q 40/00

(52) U.S. Cl. 705/44

(57) ABSTRACT

The present invention is directed to a method and system of consummating a commercial transaction between the customer and a merchant. A mobile device, such as a mobile phone would be provided with a special application allowing a customer to enter information relating to a particular purchase at a merchant's premises or, online, and then to transmit this information to an administrator for the approval of the purchase. If the purchase has been approved, this information would be transmitted in real time to both the customer's mobile device as well as to a merchant's terminal. The system and method of the present invention would be initiated by the customer and is generally wireless and can be done without the customer being physically in possession of their credit or debit card.

### CROSS-REFERENCE TO RELATED APPLICATION

The present application claims the benefit of provisional patent application Ser. No. 61/272,593, filed on Oct. 9, 2009, the subject matter of which is incorporated by reference.

### FIELD OF THE INVENTION

The present invention is directed to a method and system for conducting business utilizing a customer's mobile device including a software application therein, as well as software application included in a merchant's terminal, in combination with a hosted electronic wallet for allowing a commercial transaction to be consummated.

### BACKGROUND OF THE INVENTION

Historically, when a customer wishes to make a commercial transaction at a merchant's location utilizing a credit or debit card, the customer would present the card to the merchant for approval of the transaction. A sales slip would be generated and the customer would present their card to the merchant. At this point, the card which generally includes a magnetic strip provided with information relating to the customer's card number and the issuing bank or other entity would be transmitted along with information relating to the merchant and the amount of the transaction to a central processing unit. This central processing unit would utilize various criteria for determining whether the transaction should be approved or declined. Information relating to the approval or disapproval of the transaction would then be transmitted back to a terminal located in the merchant's facility which initiated the transaction. Generally, the information contained on the customer's credit/debit card as well as information produced by the merchant would be transmitted to the central processing unit via a telephone link. This same telephone link would be utilized by the central processing unit to transmit to the merchant's terminal whether the transaction was approved or declined.

As can be appreciated, the use of a credit/debit card can be potentially detrimental to the customer. The previously described methodology of obtaining approval or disapproval of a transaction is predicated upon the customer providing the merchant with a credit/debit card. However, if this card is lost or the customer fails to have the card in his or her wallet, it cannot be presented to the merchant. Additionally, particularly in the location in which the card is taken from the customer and then returned at a later time, such as in a restaurant, information contained on the exterior surface of the card, such as the credit or debit card number could be copied by one of the merchant's employees for nefarious uses. Additionally, various devices have been developed in which the material included on the magnetic strip of the average credit/debit card can be read and then illegally utilized.

Therefore, a system and method must be developed in which the customer need not be in possession of his or her credit/debit card for the transaction to be completed.

### SUMMARY OF THE INVENTION

The deficiencies of the prior art by the system and method utilized by the present invention are addressed by the present invention. The present invention is directed to a system and method of consummating a commercial transaction between an individual and a merchant, as well as between individuals themselves as well as transactions between merchants. Contrary to prior art systems in which the merchant initiates a communication between the terminal and a central processing unit for approving or disapproving the transaction, the commercial transaction according to the present invention will be initiated by the customer utilizing a mobile device, such as a Blackberry, IPOD, mobile telephone or the like. Prior to initiating the transaction, the customer must register with an administrator of the system. The customer, during this registration process, would include information relating to the accounts to be utilized by the customer to pay for various merchant's items or services. Information would also be elicited from the customer during the customer's registration process indicating whether these accounts would be used by other individuals in his or her family. Additionally, when making a payment using the system of the present invention, the customer would be able to include a measure of security when information is transferred from the mobile device to the gateway of a central processing unit though a web based system operated by the administrator. During this registration process, the identity and reliability of the customer would be checked by a third party. Once it is determined that the customer should be registered, an appropriate software application would be transmitted or downloaded to the customer's mobile device or devices. Alternatively, the software application is included in the mobile device when purchased in an inactive state. In this situation, when the customer is approved for registration, the software program will be remotely activated by the administrator. The registration process can be completed online or by telephone.

Similarly, every participating merchant must register with the administrator. After the merchant has been approved, the merchant would be assigned a particular merchant code and, if applicable, a location code and a registered employee code. The appropriate software application would be transmitted to the merchant's location for the purpose of receiving information on a mobile device, a computer or the like, regarding the approval or disapproval of a particular customer's transaction. Additionally, appropriate signage would be physically supplied to the merchant which could include, at the very least, an assigned merchant's code which would be entered by the customer in the customer's software application for completing and transmitting information relating to a particular transaction.

The method of utilizing this payment system will now be explained. Once a customer is notified of the amount of a particular purchase or purchases, the customer would depress a particular icon relating to the special software application included in his or her mobile device. The customer would then be prompted to enter a particular password. Once the password is deemed to be correct, a payment screen would appear on the mobile device. The customer would then enter the total cost of the purchase or purchases along with a tip, if appropriate. The customer would also enter the merchant code, as well as, if appropriate, a location code and a registered employee code. Once this information is entered on the payment screen, additional security codes may be required to be entered. At this point, the customer would then initiate a communication between the customer's mobile device and the administrator's computer system. This transmission is done securely over the internet. The transaction would then be transmitted from the administrator's server to a central processing unit which would either approve or decline the transaction. Notification of whether the transaction has been approved or declined would be immediately transmitted to the customer's mobile device. This same notification would be provided to the merchant via the software application on the merchant's mobile device or computer.

As described, the method and system of the present invention need not require the customer to present the credit/debit card to the merchant. Rather, information relating to the customer's credit or debit card numbers along with the issuing bank or other entity would be transmitted from the customer's mobile device through the administrator's computer server to a central processing unit for approval of the transaction. Although the present invention is described with a customer using a credit/debit card, the system could also operate using prepaid cards, gift cards, bank accounts, closed loop cards or other types of devices to effectuate the transaction.

### BRIEF DESCRIPTION OF THE DRAWINGS

These and other features and advantages of the present invention will become more clearly understood in light of the ensuing description of the embodiment thereof, giving by way of example, with reference to the accompanying figures, wherein:

FIG. 1 is a block diagram showing the main components of the present invention;

FIG. 2 is a block diagram outlining the method of operation of the present invention including showing how a customer would register;

FIG. 2A is a block diagram showing how a merchant would register;

FIG. 3 is a diagram showing one customer user screen;

FIG. 4 is a diagram showing a second customer user screen;

FIG. 5 is a diagram showing a third customer user screen; and

FIG. 6 is a diagram showing a merchant authorization response screen.

### DETAILED DESCRIPTION OF THE PREFERRED EMBODIMENTS

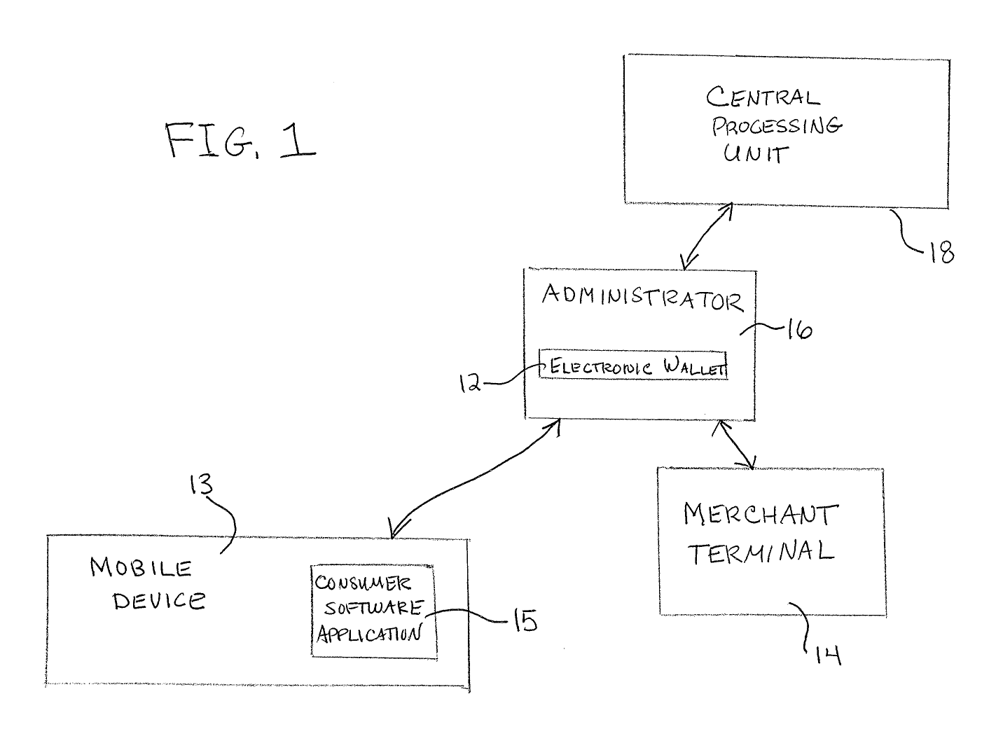

FIG. 1 illustrates the main components of the present invention 10. These components include a mobile device 13 having a consumer software application 15, a customer electronic wallet 12 as well as a merchant terminal 14. The electronic wallet 12 which includes secured information, such as the credit card number of the customer would be provided on the server of an administrator 16. The mobile device 13 could be a Blackberry, a mobile telephone, an IPOD or the like. Initially, as will be explained in more detail, the customer would register with an administrator 16 by providing the administrator with information relating to the type of credit and debit cards, prepared, gift, closed loop cards, as well as bank accounts which would be utilized to pay various bills. Additionally, the account numbers would be relayed to the administrator for each of the accounts which would be utilized. This information would be stored in the electronic wallet 12 provided in the administrator's server. The initial interface with the administrator could be done via the internet in which the customer would visit the administrator's website or, it could be done by telephone. The administrator itself would check and verify information provided by the customer. Alternatively, such information can be verified using a third party. Once the identity and the information received from the administrator 16 by the customer are validated, the customer would be approved to use the system of the present invention. At this point, the software application 15 allowing the customer to utilize the system of the present invention would be downloaded or transmitted to the customer's mobile device. The number of the mobile device may be given to the administrator.

Similarly, each merchant who wishes to participate in the system of the present invention must also register with the administrator 16. Various information would be provided from the merchant to the administrator which would be verified by the administrator 16 or by a third party. Once the merchant has been approved, a special merchant code would be assigned to the merchant. If the merchant operates at a number of locations, each location would be assigned a separate location code. Additionally, the instance in which a merchant is a restaurant, each employee can be assigned a particular employee code, facilitating the payment of a tip from the customer to the employee. Further, a code for each of the merchant's locations could be assigned. Once all the merchant information has been verified, a software application would be downloaded or transmitted to each of the merchant's terminals 14. The terminal 14 could be associated with a cash register, mobile phone, IPOD, or could be a separate terminal assigned to this system.

Once a purchase is made and the customer utilizes the system of the present invention to pay the merchant, the customer would initiate an electronic transfer of information from the software application 15 in the mobile device 13 to the administrator 16. The administrator would combine the merchant and consumer data and then relay this information to a central processing unit 18 which would either approve or decline the transaction based upon information provided in the central processing unit's computer system. This information would include the various accounts that each customer would utilize as well as the issuing and acquiring banks as well as other information relevant to the approval/decline decision. Once a decision is made, the approval/decline decision would be transmitted from the central processing unit 18 to the administrator 16 who in turn would transmit the approval/decline decision to both the mobile device 13 as well as the merchant terminal 14. The approval/decline decision would be stored by the administrator in the mobile device 13, as well as in the merchant terminal 14. Assuming that the purchase has been approved, the customer could then receive the appropriate paper sales receipt from the merchant.

Once the transaction has been approved, the customer can sign the transaction using their mobile device, if this feature is supported by their device. This signature would be retained by the administrator 16. Information regarding a particular transaction may be reviewed at a later date by the customer and the merchant logging onto the administrator's website.

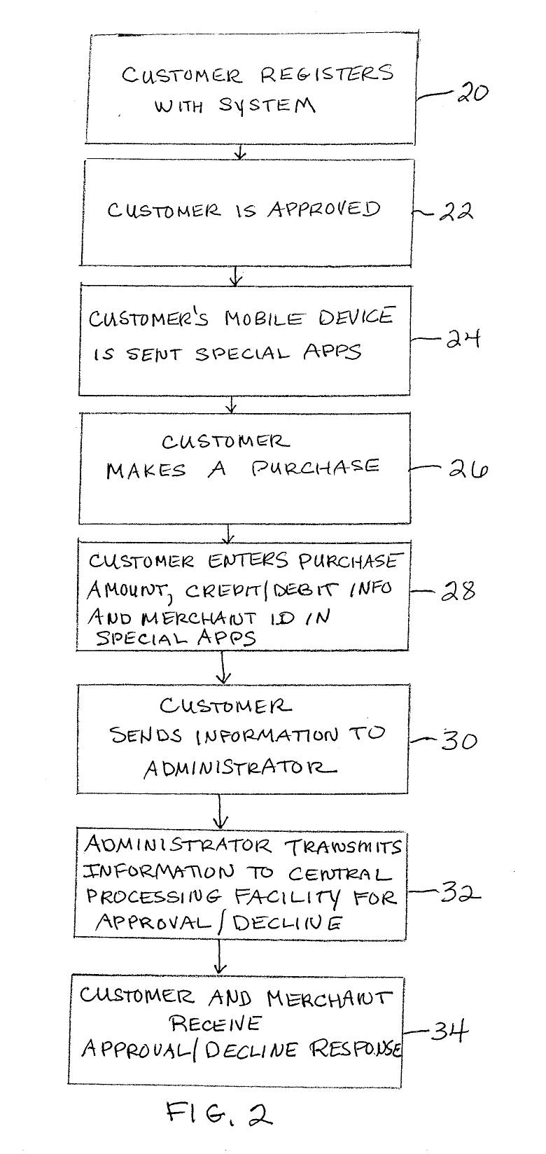

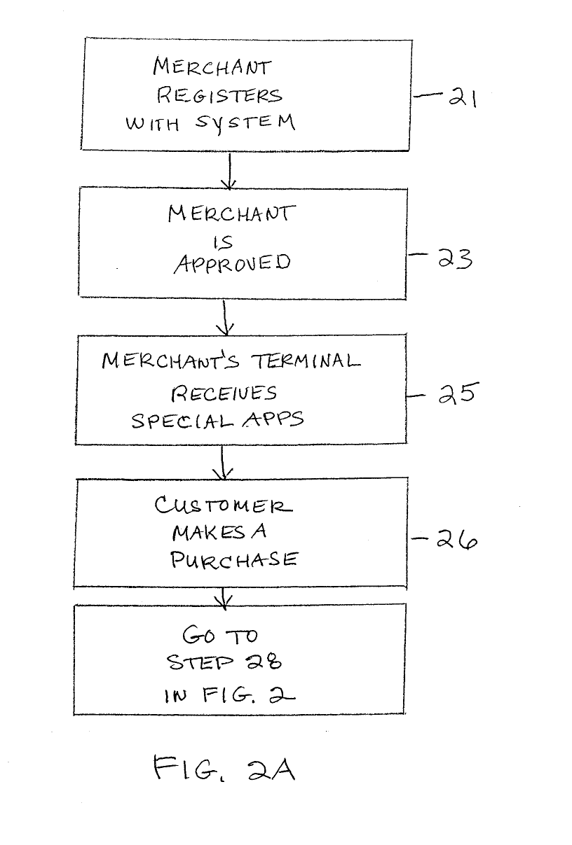

FIG. 2 illustrates the method of the present invention particularly with respect to the customer's point of view. As previously indicated and will be described in more detail, a customer would register with the web based system at Step 20. During this step, the customer would provide the system with bank account or credit/debit card information. This information could also include the use of prepaid, gift and loyalty cards. The customer would also provide details for managing the electronic payment preferences for later use at the point of sale in combination with the appropriate application on the customer's mobile device. These preferences might include which credit/debit or bank account the customer would utilize if none was specifically relayed to the administrator at the time a transaction is made. These preferences might also include a specific order in which the various accounts of a customer would be utilized. The administrator would then utilize the information provided by the customer during the registration step to determine whether the customer would be approved to use the system of the present invention. This approval would be made at Step 22 by the administrator or by a third party. This approval might be conditional in that the customer might be approved to utilize one or more of the credit/debit or bank accounts, but not all of these accounts. Once the customer is approved, the approval would be transmitted to the customer along with a special application to allow the customer to participate in the system of the present invention as shown in Step 24.

FIG. 2A is a block diagram showing the manner in which a merchant would register with the system as shown at Step 21. This step would entail the merchant entering the administrator's website and clicking onto a page reserved for the merchant registering with the system. The web page would include a number of prompts allowing the merchant to register smoothly with the system. These prompts would require the merchant to provide the administrator with various information relating to the merchant's business. This information would be verified by the administrator or third party and approval would be given or declined to the merchant based upon this information. Once the merchant is approved at Step 23, the merchant's terminal or terminals would be downloaded or transmitted the appropriate special software applications at Step 25 for allowing the merchant to participate in the system of the present invention. Once the merchant is registered and is in possession of the appropriate software applications, when a customer makes a purchase at Step 26, the system would then proceed in the manner illustrated in FIG. 2 in which the transaction is consummated and the customer and the merchant would receive an approval/decline response from the administrator.

The customer would now enter a participating merchant location and make a purchase at Step 26. The consumer would be alerted that the merchant is a participant in the present system by the use of various signages posted at appropriate locations outside of the merchant's establishment as well as inside the merchant's establishment. This signage would be supplied by the administrator 16 and would include a merchant's code, as well as optional register codes, location codes as well as optional employee codes. The employee code would be particularly important if the merchant is a restaurant and the employee would receive tips from the customer. After the customer chooses a particular item to be purchased, the transaction would be completed in accordance with the merchant's usual business practice.

Once the customer receives notification of the total cost of the purchase, their mobile device 13 would be initialized, and a particular icon associated with the application for having the customer complete the purchase would be utilized. The customer would then login, enter the purchase amount, the merchant's code, as well as any additional information which would be relevant to the purchase in various screens generated by the special applications in Step 28. The special applications might also include various levels of security that the customer would utilize in transmitting information from their mobile device 13 to the administrator 16.

Information relating to the customer's transaction would be sent only from the customer's software 15 to the administrator at Step 30. This step is not initiated by the merchant. This information, at Step 32 would be transmitted from the administrator to the central processing unit 18 for the approval or the declining of the transaction. Once this determination is made by the central processing unit 18, it will be relayed in real time to the administrator 16 as well as to the customer's mobile device 13 and the merchant terminal 14 at Step 34.

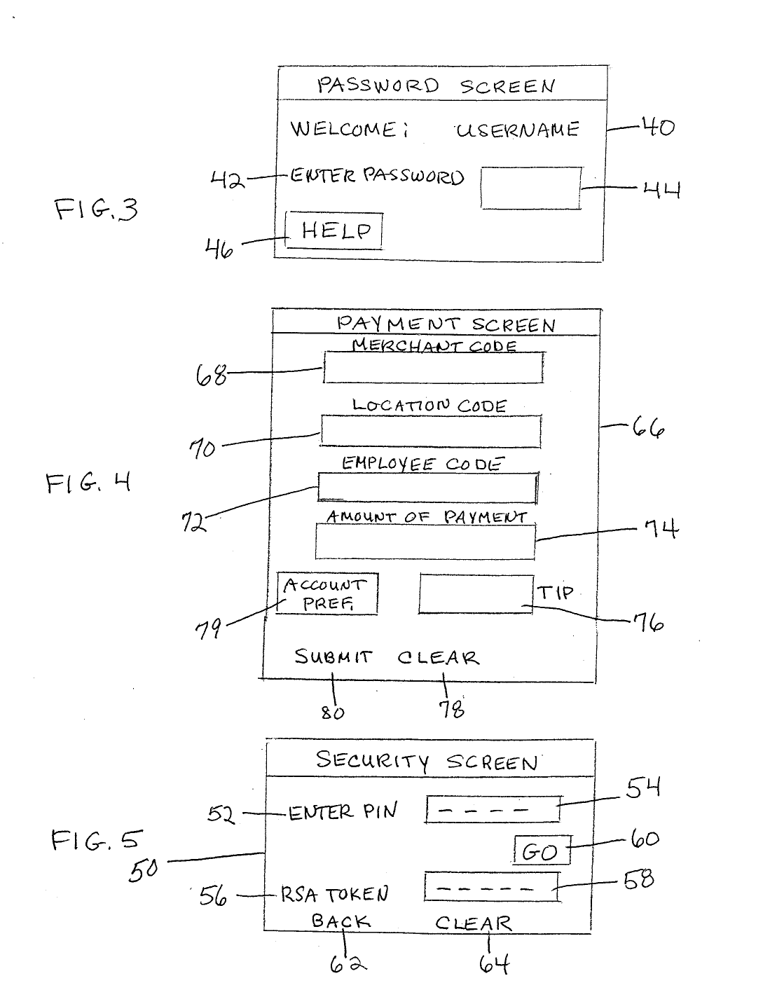

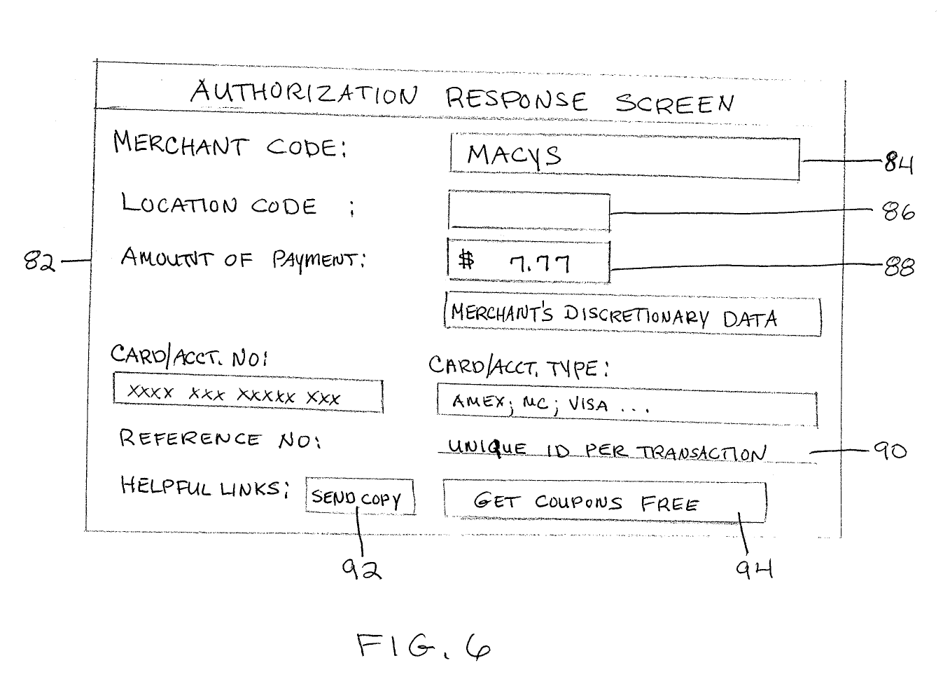

FIGS. 3, 4 and 5 illustrate typical screens that the customer would utilize during the payment process. As previously indicated, once a merchant would provide the customer with the total cost of a purchase, the customer would utilize the mobile device 13 with the special application software 15 thereon, to complete the transaction. The mobile device would include an icon used to initiate the special software application used to allow the customer to transmit the information relating to the purchase directly to the administrator 16, which includes in their server the electronic wallet 12 and any card account data. It is noted that the icon that the customer would utilize would be chosen during the customer's registration process. Once this icon is touched to start the payment process, a password screen 40 would be displayed. This password screen 40 would prompt the customer at 42 to enter the customer's password in box 44 using the keypad associated with the mobile device. If the customer is having problems, such as not remembering their password, a HELP button 46 can be used. If after prompting the customer could not enter the proper password, an appropriate message would be sent to the customer indicating that the payment process cannot proceed.

Once the password has been entered, a payment screen 66 would be displayed. This payment screen would allow the customer to enter the displayed merchant code in box 68. Additionally, the customer would have the opportunity to enter, if appropriate, a particular location code of the merchant in box 70 as well as an employee/register code in box 72. The customer would then enter the total amount of payment in box 74 and, if appropriate, a tip in box 76. Alternatively, if an employee code was entered in box 72, the amount of payment entered in box 74 could contain both the total cost of the service provided by the merchant along with a tip amount. The payment screen 66 would also allow the customer to link to administrator at box 79, to edit specific accounts which would be utilized or another type of account preference. The payment screen 66 could also include a button 78 to clear the information if the entered information is incorrect, allowing the customer to enter the proper information. Once the proper information is entered, the customer would then hit the SUBMIT button 80 transmitting all the information relating to the purchase to the administrator 16 for determining whether the purchase would be approved or declined. It is important to emphasize that since the customer's credit/debit account information, such as the complete credit/debit card number is already included in the electronic wallet 12, this information is not sent from the customer to the administrator 16 or given to the merchant when the credit/debit card purchase is consummated.

During the customer's initial registration process, the customer would be given the option to provide an additional level of security. If the customer opts to utilize only a basic password, the proper password screen 40 would be displayed as illustrated with respect to FIG. 3. Once the password has been properly entered, the payment screen 66 would be displayed. Once all the appropriate information has been entered in the payment screen 66, this information would be sent to the administrator. However, the customer could utilize an additional level of security such as with a PIN or RSA token. This particular security screen 52 would be displayed after all the information has been entered in the payment screen 66. The security screen 50 would prompt the customer at 52, to enter their PIN number in box 54. Additionally, or alternatively, the customer would, at 56 be prompted to enter their RSA token in box 58. A CLEAR button 64 is also provided as well as a BACK button 62 allowing the customer to return to the payment screen 66. Once all of the required information is entered in the security screen 50, the customer would touch the GO button 60 to send the information to the administrator 16 as previously described.

Once the determination is made to approve or to decline the purchase, this decision would be transmitted by the administrator 16 as well as to the customer's software application 15 within the mobile device 13 and the merchant's terminal 14.

FIG. 6 shows a typical merchant's authorization response screen 82. This response screen would include the merchant's code in box 84, a location code in box 86, as well as the amount of the purchase price in box 74 in FIG. 4. This amount would also appear in box 88 of FIG. 6. This screen 82 would also include additional data which is discretionary to the merchant's, such as the employee or register that made the purchase. The merchant's authorization response screen 82 would also include only a portion of the account number that the customer has utilized and has been approved to use. A reference number, as shown in box 90, would be transmitted to the merchant for each approved purchase. Once the transaction has been approved, a copy of the approved transaction can be printed and given to the customer at box 92. Box 94 would include various other offers or additional material that can be provided to the merchant as well as the customer.

Information would be included on the administrator's website helping the customer to properly complete the registration process. This information could include preferences for the customer's account. The customer could enter a number of different accounts and would be able to designate that one or more of these accounts be used by other members of his or her family, as well as any credit limitations on the sub accounts. If the customer has designated additional people to utilize the account, information relating to these other individual's mobile unit, such as the phone number, would be included. Upon approval, these additional individuals will be sent the special application needed to utilize the system according to the present invention. The administrator's website could also include options relating to the type of icons which would be employed as well as the design of the electronic wallet and the various screens that would be displayed during the purchasing process.

While the invention has been described with respect to a limited number of embodiments, these should not be construed as limitations in the scope of the invention, but rather as examples of some of the embodiments. Those skilled in the art will envision other possible variations, modifications and programs that are also within the scope of the invention. Accordingly, the scope of the invention should not be limited by what has thus far been described. Therefore, it is to be understood that alternatives, modifications and variations of the present invention are to be construed as being within the scope and spirit of the crux of the invention. For example, FIGS. 3-6 illustrate various screens that can be utilized. The information included in these screens can be altered and changed. Additionally, while the invention primarily describes its use when a customer is physically present at the merchant's location, the present invention can also be used to make online vending, unattended, or other types of purchases.

What is claimed is:

1. A software application to be used in conjunction with a mobile communications device having a display and input device for consummating a credit/debit card purchase, the mobile communications device in remote communication with an administrator, the software application comprising:
entering means for generating a first screen on the display, said first screen allowing a user to enter information relating to a credit/debit card purchase using the input device;
transmission means in conjunction with the mobile communication device for sending said information relating to the credit/debit card purchase to the administrator; and
receiving means for receiving an approval/disapproval response from the administrator;
wherein the information sent from the software application to the administrator regarding the credit/debit card purchase does not include the credit/debit account number.

2. The software application in accordance with claim 1, wherein said entering means includes a provision for entering a merchant code which is sent to the administrator.

3. The software application in accordance with claim 2, wherein said entering means includes a provision for entering a location code and an employee code.

4. The software application in accordance with claim 1, wherein said entering means allows the user to enter a password using a second screen and said information relating to a credit/debit card purchase is entered using said first screen.

5. The software application in accordance with claim 4, further including a security screen for entering a PIN or RSA token prior to utilizing said transmission means to send said information to the administrator, thereby providing a secure transmission from the mobile communications device to the administrator.

6. The software application in accordance with claim 4, wherein said first screen allows the user to designate a particular credit or debit card to consummate the credit/debit card purchase.

7. A method for facilitating a commercial purchase between a customer and a merchant, including the steps of:
a) the customer applying with an administrator for registration, said registration step including at least one credit card or debit card account number provided to the administrator;
b) approving the registration of the customer, thereby allowing the customer to utilize the administrator to approve or deny the consummation of the commercial purchase;
c) providing the customer with a software application to be used in conjunction with a mobile communications device, or activating the software application already provided in the mobile communications device;
d) using said software application by the customer to enter information regarding the commercial purchase, said information not including the credit card or debit card account number of the customer;
e) sending the information entered in step d) to the administrator using the mobile communications device;
f) determining whether the commercial purchase was approved or declined; and
g) informing the customer whether the commercial purchase was approved or denied.

8. The method in accordance with claim 7, further including the steps of:
the merchant applying to register with the administrator to allow said merchant to participate in the commercial purchase with the customer;
approving said merchant to participate in the commercial purchase with the customer;
providing said merchant with a merchant code;
having the customer include said merchant code with said information regarding the commercial purchase sent to the administrator by the customer; and
said merchant receiving a determination regarding the approval or denial of the commercial purchase.

9. The method in accordance with claim 8, including the step of providing said merchant with a location code and employee code, said location code and said employee code to be included with said information regarding the commercial purchase sent to the administrator by the customer.

10. The method in accordance with claim 8, further including the step of said merchant providing the customer with a written copy of the approved commercial purchase.

11. The method in accordance with claim 8, further including the steps of:
the administrator combining said information regarding the commercial purchase with information relating to the merchant;
sending the information included in the previous step to a central processing unit to determine whether the commercial purchase has been approved or denied;
the administrator being informed by said central processing unit whether the commercial purchase has been approved or denied; and
the administrator informing the customer and the merchant whether the commercial purchase has been approved or denied.

12. A system for facilitating the consummation of a commercial purchase between a customer and a merchant, comprising:
a mobile communications device;
a software application provided in said mobile communications device, said software application including screens allowing a customer to enter information relating to a commercial purchase, said information not including credit or debit account information of the customer;
an administrator provided with at least one credit/debit account information of the customer, said administrator receiving said information relating to the commercial purchase entered by the customer and sent to said administrator by said mobile communications device, said administrator informing the customer whether the commercial purchase was approved or denied.

13. The system in accordance with claim 12, wherein said administrator registers the customer card and the merchant prior to the commercial purchase being initiated.

14. The system in accordance with claim 13, wherein said administrator provides the merchant with a merchant code, said merchant code to be visibly displayed at the merchant's establishment.

15. The system in accordance with claim 12, further including a central processing unit in communication with said administrator for approving or denying the commercial purchase.

16. The system in accordance with claim 12, wherein said information relating to a commercial purchase includes a merchant code.

17. The system in accordance with claim 12, wherein said information relating to a commercial purchase includes a location code and an employee code.

18. The system in accordance with claim 12, wherein said administrator provides the customer with a password allowing the customer to utilize the system.

19. The method in accordance with claim 7, further including the step of providing the customer with a password allowing the customer to utilize the system.
